(19) United States
(12) Patent Application Publication
(10) Pub. No.: US 2006/0280851 A1
(43) Pub. Date: Dec. 14, 2006

(54) Food grade antioxidant and flavorant from roasted wheat malt

(76) Inventor: Paul R. Pike, Toronto (CA)

Correspondence Address: GRACE J FISHEL, 2200 WEST PORT PLAZA DRIVE, SUITE 202, ST. LOUIS, MO, 63146, US

(21) Appl. No.: 11/222,683

(22) Filed: Sep. 9, 2005

Related U.S. Application Data
(60) Provisional application No. 60/608,681, filed on Sep. 10, 2004.

(51) Int. Cl. A23L 2/56

(52) U.S. Cl. 426/533

(57) ABSTRACT

A food grade antioxidant and a baked food flavorant is isolated from roasted wheat malt containing bran. The germinated wheat is roasted until the malt's naturally occurring enzymes are substantially destroyed. The roasted wheat malt is milled into fine particles that may be physically separated into a fraction that is primarily homogeneous bran particles and into a fraction that is primarily heterogeneous endosperm and germ particles. The bran fraction is useful as a food flavorant and the endosperm and germ fraction may be used directly as an antioxidant for oils and fats, or foods, pharmaceuticals and cosmetics containing oils and/or fats or the antioxidant may be chemically extracted. The milled homogeneous bran and heterogeneous endosperm and germ particles may be recombined in customized proportions and thus used as a dually functional food ingredient.

This application claims priority from provisional application serial No. 60/608,681, filed Sep. 10, 2004, for Food Grade Antioxidant and Flavorant From Roasted Wheat Malt.

### BACKGROUND OF THE INVENTION

1. Field of the Invention

The present invention relates to a roasted wheat malt derived antioxidant and food flavorant which may be incorporated into oils and fats, or foods, pharmaceuticals and cosmetics containing oils and/or fats.

2. Brief Description of the Prior Art

Modern formulations for traditional food products which are devised to reduce or remove trans-fats are often more susceptible to oxidation than the original formulations. Formulators are faced with difficult choices as new fats are selected. Tropical oils which may contain little or no trans-fats are highly saturated and thus do not meet the requirements for “healthy” food products. Domestic oils such as soy and cottonseed, while very low in trans-fats, are very susceptible to oxidation. BHT and other synthetic antioxidants which can control this oxidation do not fit into the “healthy” labeling requirements for these products.

Baked products such as breads, crackers, backed snack foods and direct expansion cereal products produced by modern high speed production methods often lack the naturally developed baked flavors that consumers expect in these products. Direct expansion snack and breakfast cereal products are often dried by a method that produces a low level of flavors from browning. A naturally occurring flavorant to augment the baked flavor of these products would find utility.

Recent academic studies demonstrate that cereal malts contain antioxidant properties but neither malted barley nor malted oats can be fractionated into two portions: A homogeneous bran portion, which is free of hull and trichome material, and a heterogeneous endosperm and germ mixture portion. Both the hull and trichome material comprise insoluble fiber and are considered inedible for human consumption. Additionally, the trichome material in oats tends to cause irritation reactions whenever consumed or inhaled and thus is not permitted in food products. Removing the hull and trichome material is necessary prior to using fractionated cereal malt as a food ingredient.

In barley grain, the pearling process removes the hull and bran material of barley; however, the germ is concurrently physically damaged, seed vitality is impaired, and incomplete germination results during malt processing. Consequently, poor germination of pearled barley yields malt of inferior quality.

In oat grain, impact or compressed-air dehulling methods remove the hull material, preserves the bran portion, and is less physically damaging to the germ thus preserving seed viability for subsequent germination during malt processing. A secondary physical process called polishing removes the trichomes (tiny hairs) located on the outside of the oat kernel. The combined two-step process of physically removing the hull and trichome material from the oat kernel has the potential to compromise seed vitality and thus reduce complete germination during malt processing. On the other hand, applying the oat hulling method produces broken kernels because the malted oat kernel is more fracturable because of malting. Furthermore, the density is similar between the oat malt kernel and hull material thus impeding efficient separation of these components. The contributing factors necessary to achieve oats free of hull and trichome material with respect to the dehulling inefficiencies and the probability of compromised oat kernel vitality prior to malting describes a complex manufacturing process having limited commercial interest.

Wheat malt, on the other hand, can be directly milled into a bran portion and an endosperm and germ mixture portion that is free of hull and trichome material because the wheat hull is removed during threshing and trichome material is absent on the kernel of wheat species. It was not previously recognized that a baked flavor can be developed in the bran portion if the germinated wheat is roasted. Nor was it recognized that the endosperm and germ mixture portions contains antioxidants, which may be used as a replacement for BHT in foods products. Value added food processing benefits are thus achieved when the same malt can be milled into a fraction yielding a flavorant and a fraction yielding antioxidants.

As background, recent academic studies on barley and oat malts show that antioxidant properties are affected by germination and malting conditions:

Work with Barley Malts

Increases in antioxidant activity in barley malt compared to raw barley is discussed in the following articles: Goupy, P., Hugues, M., Boivin, P., Miot, M.-J. Antioxidant composition and activity of barley (Hordeum vulgare) and malt extracts and of isolated phenolic compounds. J. Sci. Food Agric. 1999, 79, 1625-1634; Maillard, M.-N., Soum, M.-H., Boivin, P., Berset, C. Antioxidant activity of barley and malt: relationship with phenolic content. Lebensm. Wiss. U. Technol., 1996, 29, 238-244; and, Maillard, M.-N, Berset, C. Evolution of antioxidant activity during kilning: role of insoluble bound phenolic acids of barley and malt. J. Agric. Food Chem., 1995, 43, 1789-1793. Other work showed that increases in malt color in the range of 15-148° EBC (European Brewing Convention units) suggest that achieving optimal conditions for Maillard reaction product formation during malt kilning increases the antioxidant activity of barley malt: Wolffenden, H. M., Ames, J. M., Chandra, S. Relationships between antioxidant activity, color, and flavor compounds of crystal malt extracts. J. Agric. Food Chem., 2001, 49, 5524-5530. The antioxidant properties of Munich-style or melanoidin-rich barley malt to inhibit the autoxidation of naturally-occurring barley fatty acids and thus improve flavor stability in beer is addressed in the following text: Briggs, D. Malts and Malting. 1^{st}, ed.; Blackie Academic & Professional:London, 1998.

Work with Oat Antioxidants

In oats, it is known that the concentration of avenanthramides, a group of phenolic antioxidants intrinsic to oats, increase in the oat endosperm upon steeping in water. It has also been reported that avenanthramides are thermally stable to steam processing. These studies may suggest that malting oats may contribute to increased antioxidant properties due to elevated levels of avenanthramides but the role of malting to increase the antioxidant properties of oats has not been reported in the scientific literature including: Bryngelsson, S., Dimberg, L. H., Kamal-Eldin, A. Effects of commercial processing on levels of antioxidants in oats (Avena sativaL.) J. Agric. Food Chem., 2002, 50, 1890-1896; Dimberg, L. H., Sunnerheim, K., Sundberg, B., Walsh, K. Stability of oat avenanthramides. Cereal Chem., 2001, 78(3), 278-281; Bryngelsson, S., Ishihara, A., Dimberg, L. H. Levels of avenanthramides and activity of hydroxycinnamoyl-CoA:hydroxyanthranilateN-hydroxycinnamoyltransferase (HHT) in steeped or germinated oat samples. Cereal Chem., 2003, 80(3), 356-360; Matsukawa, T., Isobe, T., Ishihara, A., Iwamura, H. Occurrence of avenanthramide and hydroxycinnamoyl-CoA:hydroxyanthranilate N-hydroxycinnamoyltransferase activity in oat seeds. Z. Naturforsch., 2000, 55c, 30-36.

### BRIEF SUMMARY OF THE INVENTION

In view of the above, it is an object of the present invention to provide a naturally occurring antioxidant to inhibit rancidity, improve flavor stability and extend shelf life of food products. It is another object to provide a naturally occurring flavorant imparting a baked flavor to food products. It is also an object to provide a method for extracting a naturally occurring flavorant and a naturally occurring antioxidant from roasted wheat malt. Other objects and features of the invention will be in part apparent and in part pointed out hereinafter.

The present invention describes a natural antioxidant and flavorant isolated from roasted wheat malt for use in fats and oils, or products containing fats and/or oils. The malt is milled and a homogeneous bran fraction may be physically separated from a heterogeneous endosperm and germ fraction. The bran fraction imparts a baked flavor when incorporated in food products. The endosperm and germ fraction may be used as an antioxidant by direct addition into a food product containing fats and/or oils for use in inhibiting autoxidation reactions. The antioxidant present in the endosperm and germ fractions may be further purified via solvent extraction methods.

### DETAILED DESCRIPTION OF THE INVENTION

In accordance with the present invention, kernels of wheat are malted by roasting germinated grain. The roasted wheat malt is then milled and physically separated into substantially equal fractions by weight, one containing primarily a homogeneous bran portion of the roasted wheat malt and one containing primarily a heterogeneous endosperm and germ portion of the roasted wheat malt.

The bran portion of the roasted wheat malt may be further milled to reduce the particle size and used as a flavorant in extruded, direct expansion, bakery and like cereal-based products to augment the baked flavor of the product. The heterogeneous endosperm and germ portion may be used directly as a food grade antioxidant in ingredient dry blending applications. Alternatively, the food grade antioxidant may be isolated from the heterogeneous endosperm and germ portion of the roasted wheat malt by solvent extraction and used in food products where it offers the following benefits with respect to the food label:

(1) Ingredient declaration could be “wheat malt flour”, “wheat malt fractionate”, “wheat malt isolate” or the like;

(2) Expected GRAS status because it is a natural product;

(3) Non-volatile;

(4) Heat stable at temperatures commonly used in food processing;

(5) Not a suspected carcinogen like BHT;

(6) No regulatory restrictions on usage level in food products, unlike BHT; and,

(7) Application for use in the food product and not in the packaging of a food product unlike BHT which is also commonly used in the packaging.

The flavorant in the bran portion of the roasted wheat malt is heat stable under normal food processing conditions. Depending on the application, either a coarse or fine grind of the bran portion, may be preferred. For example, for whole wheat crackers, a coarse grind may be preferred as little specs of color may add to the product. On the other hand, for extruded food products, such as puffed wheat or snack crackers that are fried, a more homogeneous appearance may be desired. The bran portion also contributes to fiber content when used in a food product.

Roasted wheat malts are commercially available, one of which is sold under the trademark CaraWheat by Malteries Franco-Belges of France. The processing of CaraWheat differs from commodity brewer's malt. In CaraWheat, wheat is germinated under controlled conditions for approximately three days. On the fourth day, the germinated wheat is stewed under conditions wherein the temperature of the germinated wheat is raised in order to accelerate enzymatic reactions while minimizing physical plant growth. This process is similar to wilting. The germinated/stewed wheat is then roasted in a drum roaster at increasing temperature that is ramped over a specific time until the grain is dry to approximately 4 percent by weight moisture. In brewer's malt, the germinated barley is not stewed but rather is dried by forced air at cooler temperatures in order to preserve enzymatic activity. Enzymatic activity in CaraWheat is lost during the roasting process.

The following examples illustrate the invention.

### EXAMPLE 1

Roasted wheat malt sold under the trademark CaraWheat by Malteries Franco-Belges of France has the following specifications:

| | | |
|---|---|---|
| Moisture | 2.5% | by weight |
| Color of roasted wheat malt | 35-45° | Lovibond |
| Color of Wort (E.B.C. Method) | 103.0 | |
| Extract on Dry Matter | 80.3% | |
| Wort Color (ASBC Method) | 39.1° | SRM |

Lovibond is a common measure of color in food grade oils and is widely used in the greater food industry. The color of wort (E.B.C. Method) and wort color (ASBC Method) are closely related measurements on different scales. Wort color is important in determining the optimum amount of CaraWheat to include in a brewing formulation. Wort color is also related to the concentration and type of Maillard reaction products present in the endosperm portion of the malt.

The CaraWheat was milled in an M-21 fine grinder manufactured by Prater Industries, Inc. of Chicago, Ill. Optimum conditions for producing a product which could be air classified into two substantially equal fractions by weight were as follows:

Step A

| Mill Tip Speed | 120 | meters/sec |
|---|---|---|
| Dividers | 3 | per rotor |
| Rotor Type | fine | |
| Screen Size/Type | 0.7 | mm/triangular |
| Screen Open Area | 8% | |
| Mill Motor No Load | 19.2 | amps |
| Mill Motor Run Load | 38.3 | amps |
| Mill Motor Horsepower | 16.0 | hp |
| Feed Amount | 105 | lbs |
| Time Fed Into Mill | 8.5 | min |
| Feed Rate | 741.0 | lbs/hr |

The finely ground roasted wheat malt from the M-21 fine grinder was air classified in an MAC-1 air-classifier made by Prater Industries, Inc. An optimum combination of operating conditions to separate the product into substantially equal fractions by weight were as follows:

Step B

| | | |
|---|---|---|
| Classifier Speed | 800 | rpm |
| Classified No Load | 2.1 | amps |
| Classified Run Load | 2.5 | amps |
| Total Air | 9.17 | CFM |
| MAC Secondary Air | 80% | Open |
| MAC-DC Static | 7.0 | |

The results were as follows:

| | |
|---|---|
| Thrus (fine particles) | Overs (coarse particles) |

| | | | |
|---|---|---|---|
| 66.2 | lbs | 53.2 | lbs |
| 55.4% | Yield | 44.5% | Yield |
| 16% | Retained by 325 Mesh | 94% | Retained by 325 Mesh |
| 0.4% | Retained by 80 Mesh | 75% | Retained by 200 Mesh |
| | | 33% | Retained by 100 Mesh |

The thrus contained the endosperm and germ portion of the roasted wheat malt and the overs contained the bran portion.

The overs were remilled on an M-21 under the following combination of conditions which were found to be optimum:

Step C

| Mill Tip Speed | 120 | meters/sec |
|---|---|---|
| Dividers | 6 | per rotor |
| Rotor Type | fine | |
| Screen Size/Type | 0.7 | mm/triangular |
| Screen Open Area | 8% | |
| Mill Motor No Load | 17.0 | amps |
| Mill Motor Run Load | 32.0 | amps |
| Mill Motor Horsepower | 13.0 | hp |
| Feed Amount | 93 | lbs |

No separation of coarse and fine particles could be achieved with a MAC-1 air classifier on the remilled overs. All the product obtained from the M-21 was fines with a composition of predominant bran. After remilling, 0% of the bran was retained on a 100 mesh screen and 0% was retained on a 200 mesh screen.

The processing conditions described in this example using a M-21 fine grinder and a MAC-1 are optimized parameters for small-scale milling of roasted wheat malt on this particular equipment. Optimal conditions may differ using larger scale fine grinders and air classifiers, however the physical process achieved should remain similar to that described above. Factors that would change processing conditions upon using large scale milling equipment may include material flow rate, particle residence time inside the fine grinder and air classifier, reducing heat created by friction, etc. The present invention is therefore not limited to the particular equipment or processing conditions described as optimum.

### EXAMPLE 2

Crackers were prepared with the remilled coarse particles from Step C example 1 as a flavorant. The formula for the control batch of crackers was as follows:

| Percent by weight | Ingredient |
|---|---|
| 7.50 | All purpose flour |
| 1.50 | 42 DE corn syrup |
| 5.00 | Sugar |
| 0.60 | Salt |
| 0.40 | Baking soda |
| 0.60 | Sodium acid pyrophosphate |
| 14.00 | Water at 90° F. |

The above ingredients were mixed together for one minute on a planetary mixer using a paddle. The paddle was replaced with a dough hook and 57.70 percent by weight pastry flour was added and mixed for five minutes on medium speed. Water was added if necessary to achieve a very firm dough.

The dough was then covered and rested for 10 minutes. The dough was rolled out and then folded over to simulate lamination. It was then rolled out to one millimeter thickness and cut into cracker shapes. A topping of 0.70 percent by weight salt was applied and adhered with the aid of water spray. The crackers were then baked at 400° F. for five minutes. Temperature in the oven was reduced to 200 to 220° F. and the crackers dried until the moisture level was in the 2 to 3 percent range. The dried crackers were then sprayed with 12.00 percent by weight oil.

A test batch of crackers were made as described above except that 5.00 percent by weight of the pastry flour was replaced with remilled coarse particles from Step C example 1 as a flavorant.

The test crackers had a light tan color and pleasing baked-flavor notes which were not present in the control crackers. No adjustment in water was necessary and the doughs handled in a similar manner.

### EXAMPLE 3

Antioxidants may be extracted from the fine particles from Step B with either organic solvent methods or CO₂ supercritical fluid extraction technology. The extracted antioxidants may then be used in the food industry to extend shelf-life of products. The antioxidant may be used to replace BHT as a GRAS status, heat stable, and non-volatile antioxidant in most bakery, snack and ready-to-eat breakfast cereal applications. BHT is a regulated antioxidant in food products with an upper usage limit of 75 ppm because it is a suspected carcinogen. On the other hand, the malt antioxidant extracted from the heterogeneous endosperm and germ fraction of roasted wheat malt would not have any regulatory usage limit.

EXAMPLE 4

Antioxidant tests were made with CaraWheat milled as described in Example 1. In the following tables, this material is identified as “Crude Antioxidant” and contains a mixture of the bran, endosperm and germ. Antioxidant tests were also made with the fine particles from Step B in Example 1. This material is identified as “Refined Antioxidant” in the following tables and contains the milled and classified heterogeneous endosperm and germ fraction. BHT at 75 ppm, which is the upper regulatory limit for BHT in a food product, was used as a control

The tests observed the increase in peroxide value measured in milliequivalents lipid peroxide per kg (meg/kg) in stripped corn oil at 25° C. and 100° C. over a period of 206 hours. The 25° C. conditions represent the antioxidant protection against oil oxidation at ambient conditions for most bakery or snack-type food products on the retail shelf. The 100° C. conditions represent accelerated oxidation conditions that are experienced during food processing, e.g., baking, extruding, jet puffing, etc. The stripped corn oil is native oil containing no added antioxidants; usually antioxidants are added to oil during processing in order to preserve its quality. The stripped corn oil contained 0.05 meg/kg of oxidized material prior to the test.

The results reported in the following tables were performed by SafTest Inc., 2414 W. 12^{th} Street, Suite 4, Tempe, Ariz. 85281 using a proprietary processed called the SafTest® System. The SafTest® System is recognized by the American Oil Chemists' Society. An error rate in the peroxide values (meg/kg) is within 2%.

The mechanism of oil oxidation is a chain-reaction involving a lipid peroxide free-radical. As oxidation continues in the oil over a period of time and influenced by temperature, a chain-reaction begins a logarithmic increase in lipid peroxides. In the tests reported in the following tables, the data taken at 72 hours is at the inflection point of the logarithmic curve, or in other words, the time at which the lipid peroxide free-radicals have accumulated in enough concentration to begin a rapid chain-reaction of oxidation.

TABLE 1
Sample Treatments at 25° C.

| | 72 hrs Meq/Kg | 206 hrs Meq/Kg |
|---|---|---|
| BHT 75 ppm 25 C. | 0.30 | 0.64 |
| Corn Oil 25 C. | 0.27 | 0.63 |
| 1% Refined Antioxidant 25 C. | 0.17 | 0.40 |
| 1% Crude Antioxidant 25 C. | 0.14 | 0.45 |
| 3% Crude Antioxidant 25 C. | 0.12 | 0.33 |
| 3% Refined Antioxidant 25 C. | 0.10 | 0.30 |

TABLE 2
Sample Treatments at 100° C.

| | 4 hrs | 72 hrs | 206 hrs |
|---|---|---|---|
| | Meq/Kg | Meq/Kg | Meq/Kg |
| Corn Oil 100 C. | 0.37 | 4.51 | 29.8 |
| BHT 75 ppm 100 C. | 0.40 | 4.06 | 27.4 |
| 1% Refined Antioxidant 100 C. | 0.19 | 3.75 | 31.8 |
| 1% Crude Antioxidant 100 C. | 0.28 | 3.58 | 32.0 |
| 3% Crude Antioxidant 100 C. | 0.11 | 2.54 | 27.6 |
| 3% Refined Antioxidant 100 C. | 0.05 | 1.74 | 25.8 |

By comparing the results with the Refined Antioxidant and the Crude Antioxidant, the data show that fractionating the roasted wheat malt into a heterogeneous endosperm and germ fraction and a homogeneous bran fraction improves the antioxidant properties of the Refined Antioxidant. This is most apparent at the 3% by weight usage rate. At the 1% by weight usage rate, the antioxidant properties of both the Refined Antioxidant and the Crude Antioxidant are comparable to each other and to that demonstrated by 75 ppm BHT at 25° C. and 100° C. At the 3% by weight usage rate, Refined Antioxidant significantly exceeds the antioxidant properties of BHT under accelerated oxidative conditions (100° C.) and at ambient conditions (25° C.).

The refined antioxidant and “Baked Flavorant” from Step C in Example 1 may be recombined in customized proportions and thus used as a dually functional food ingredient to meet the antioxidant and flavor requirements of the particular food product.

In view of the above, it will be seen that the several objects of the invention are achieved and other advantageous results attained. As various changes could be made in the above methods and compositions without departing from the scope of the invention, it is intended that all matter contained in the above description shall be interpreted as illustrative and not in a limiting sense.

What is claimed:

1. An antioxidant for oils and fats and foods, pharmaceuticals and cosmetics containing oils, fats and combinations thereof comprising a fraction isolated from a wheat malt containing bran wherein the malt's naturally occurring enzymes are substantially destroyed when the malt is roasted, said isolated fraction being primarily a heterogeneous endosperm and germ mixture.

2. The antioxidant of claim 1 wherein the malt is roasted to a color of at least 20° Lovibond.

3. The antioxidant of claim 1 wherein the wheat malt is germinated and then stewed under conditions wherein the temperature of the germinated wheat is raised in order to accelerate enzymatic reactions before the malt is roasted.

4. A flavorant for imparting a baked flavor to food products comprising a fraction isolated from a wheat malt containing bran wherein the malt's naturally occurring enzymes are substantially destroyed when the malt is roasted, said isolated fraction being primarily homogeneous bran.

5. The flavorant of claim 4 wherein the malt is roasted to a color of at least 20° Lovibond.

6. The flavorant of claim 4 wherein the wheat malt is germinated and then stewed under conditions wherein the temperature of the germinated wheat is raised in order to accelerate enzymatic reactions before the malt is roasted.

7. A method for producing a food flavorant and food antioxidant comprising
roasting a wheat malt containing bran while substantially destroying the malt's natural enzymatic activity,
milling the roasted wheat malt into fine particles,
physically separating the milled roasted wheat malt particles into a first fraction containing primarily homogeneous bran particles and a second fraction containing primarily heterogenous endosperm and germ particles, said first fraction forming the food flavorant and the second fraction forming the food antioxidant.

8. The method of claim 7 wherein the malt is roasted to a color of at least 20° Lovibond.

9. The method of claim 8 wherein the malt is roasted to a color between about 35° and 45° Lovibond.

10. The method of claim 7 wherein the wheat malt is germinated and then stewed under conditions wherein the temperature of the germinated wheat is raised in order to accelerate enzymatic reactions before the malt is roasted.

11. The method of claim 7 further comprising adding the food flavorant to a food product in a flavor altering amount.

12. The method of claim 7 further comprising adding the food antioxidant to a food product in an oxidation inhibiting amount.

13. The method of claim 11 wherein the wheat malt is germinated and then stewed under conditions wherein the temperature of the germinated wheat is raised in order to accelerate enzymatic reactions before the malt is roasted.

14. The method of claim 12 wherein the wheat malt is germinated and then stewed under conditions wherein the temperature of the germinated wheat is raised in order to accelerate enzymatic reactions before the malt is roasted.
